(19) United States
(12) Patent Application Publication
(10) Pub. No.: US 2016/0315462 A1
(43) Pub. Date: Oct. 27, 2016

(54) DIGITAL CURRENT LEAKAGE BREAKER

(71) Applicant: XENIXWIN CO., LTD, Daejeon (KR)

(72) Inventor: Youn Yell RYU, Daejeon (KR)

(73) Assignee: XENIXWIN CO., LTD, Daejeon (KR)

(21) Appl. No.: 15/106,290

(22) PCT Filed: Dec. 17, 2014
(86) PCT No.: PCT/KR2014/012455

§ 371 Date: Jun. 18, 2016

(30) Foreign Application Priority Data
Dec. 18, 2013 (KR) 10-2013-0158452

(51) Int. Cl. H02H 3/32; H02H 9/04; H02H 3/20

(52) U.S. Cl. CPC H02H 3/325; H02H 3/20; H02H 9/045

(57) ABSTRACT

The present invention relates to a digital current leakage breaker that is capable of not only preventing an overvoltage from entering a breaker and damaging the breaker by electrically insulating a power supply unit for supplying power to a current leakage breaker, but also of recording and checking the number of instances of current leakage, power outages, and incoming surges in addition to detecting current leakage, and of monitoring the amount of current presently being used in real time.

### TECHNICAL FIELD

The present invention relates to a current leakage breaker, and in particular to a digital current leakage breaker which is able to prevent any damage to a breaker by blocking the entry of an overvoltage into the breaker in such a way that a power supply unit employed to electric power to the breaker is electrically insulated.

Moreover, the present invention relates to a digital current leakage breaker which is configured not only to detect any current leakage, but also to record and check the number of current leakages, the number of power failures, and the number of surge current inputs, while monitoring in real time the currently used current.

### BACKGROUND ART

A current leakage breaker is a means to prevent any electric shock in such a way to detect a predetermined current leakage (typically, 15 mA to 30 mA). If the sum of the outgoing current and the incoming current is not zero by measuring the current which is going out to a power line and the current which is incoming to a neutral line, it is determined as a current leakage, thus breaking the current.

As illustrated in FIG. 13, the aforementioned current leakage breaker is formed of a zero-phase current transformer (ZCT) 100 which is employed to detect any current leakage at a power line, a leakage current measuring unit 200 wherein the currents measured by the zero-phase current transformer are compared, and if a result of the comparison is over a set value, it is determined as a current leakage, and subsequently, a trip driving unit 300, which will be described later, is driven, and a trip driving unit 300 wherein a breaker is activated as a larger current flows in accordance with a control of the leakage current measuring unit, and the electric power is blocked in case of a current leakage.

In the aforementioned current breaker, only the change (a change in a magnetic flux) in an input/output current of the zero-phase current transformer due to the current which flows through a power line, can be simply detected when determining any current leakage, for which if a surge current or a noise due to lightening enters via a power line, the zero-phase current transformer reacts, and the current leakage measuring unit may recognize the change in the current due to such a noise as an occurrence of a current leakage, thus activating the trip driving unit and then blocking the electric power, by means of which the electric power supplied to a predetermined load device can be blocked.

Even though a current leakage did not occur, the electric power supplied to the load device is blocked, so the load device stops, which may result in an unintentional accident. In case of a summer season where lightening occurs more often, the load device may stop frequently by mistaking the noise due to such lightening for a current leakage. In case where the load device is a computer which processes important information, the information may be lost, and in case of the load device is a medical equipment, patients may suffer from severe situations.

In order to improve the problems in the aforementioned current leakage breaker, the Korean patent registration No. 0804518 describes a current leakage breaker. As illustrated in FIG. 14, there are provided two leakage current measuring units 200a and 200b. Only if both the current leakage measuring units 200a and 200b are driven in series, the trip driving unit 300 is designed to be driven, and then the current leakage breaker is tripped.

The aforementioned current leakage breaker is able to detect any noise, thus preventing the electric power from being blocked due to such a noise, but as disadvantages the circuit configuration thereof is complicated, and an error may occur due to a relay characteristic since a time delay circuit is used as a driving time of a relay.

In order to improve the aforementioned problem, there is the Korean patent registration No. 1039351 which was invented and registered as a patent in Korea by the same applicant as the present invention. As illustrated in FIG. 15, a surge protector 500 is further provided, which is able to discharge any surge current to the ground. Since any surge current, which generates very instantly, can be discharged to the ground with the aid of the surge protector, so any damage to the load device due to the surge current can be prevented.

The conventional current leakage breaker may have an error operation since any noise enters the current leakage breaker or the current leakage breaker may be damaged. More specifically, any noise may enter the internal circuits of the current leakage breaker since the power line and the internal circuits are not electrically insulated. For this reason, the internal circuits may have error operations or may be broken up.

Moreover, the conventional current leakage breaker is designed to be blocked only when a current leakage has occurred, and it is impossible to confirm any electrical state.

### DISCLOSURE OF INVENTION

### Technical Problem

Accordingly, the present invention is made in an effort to resolve the aforementioned problems. It is an object of the present invention to provide a digital current leakage breaker which is able to prevent any error operation or damage to a breaker in such a way to block an overvoltage, for example, a surge current, noises, etc. from entering a breaker since an electric power supply unit employed to supply electric power to a current leakage breaker is electrically insulated.

Moreover, it is another object of the present invention to provide a digital current leakage breaker which is able not only to block a current leakage, but also to record, display and confirm the number of current leakages, the number of power failures, and the number of surge current entries, while monitoring in real time the currently used current.

### Technical Solution

To achieve the above objects, there is provided a digital current leakage breaker wherein a main controller operates a trip driving unit, thus blocking a main electric power, based on a leakage current which occurs at a power line and is detected using a zero-phase current transformer, which may include, but is not limited to, a power supply unit which is employed to supply electric power to the current leakage breaker and includes a primary winding connected to the power line, and a secondary winding wherein an induced current generates based on any change to the magnetic field of the primary winding, by which an electrical insulation can be made between the primary winding and the secondary winding, wherein even though an expected high voltage flows via the power line, the high voltage does not inter the current leakage breaker.

The secondary winding of the power supply unit includes a DC power unit to supply a DC power to the breaker, and two resistors (R1 and R2) are provided, which are able to block electric power if a voltage higher than a reference voltage is detected by detecting an output voltage, and a voltage between the resistor (R2) and the ground is detected, and if the detected voltage is higher than a set reference voltage, the voltage is blocked.

The zero-phase current transformer may include a converter to convert the output signal of the zero-phase current transformer, and the converter includes two channels, and the first channel is formed of a first amplifier to amplify only the value (+) among the output signals, and a first comparator to compare the amplified signal to a reference value and outputs as a pulse value, and the second channel is formed of a second amplifier to amplify only the value (−) among the output signals, and a second comparator to compare the amplified signal to a reference value and output as a pulse value.

The current leakage breaker may include, but is not limited to, a current detection unit employed to detect in real time the current which flows via the power line; a surge detector which is able to detect a surge current; an auxiliary controller which is able to store and control the detected current; and a display unit which is configured to display the detected current, the number of current leakage detections, the number of power failures, and the number of surge current entries, wherein the current detection unit includes a current transformer which is able to detect the current flowing via the power line, and an amplification unit which is able to amplify and rectify the current detected by the current transformer.

The main controller and auxiliary controller may include a watchdog timer, thus generating an interrupt and initializing the state of a system.

There may be further provided a surge protector which is installed at a front end or a rear end of the current leakage breaker connected to the main power line, thus discharging the surge current to the ground.

### Advantageous Effects of the Invention

In the digital current leakage breaker according to the present invention, a power supply unit is configured for electric power to be supplied based on an induced current, so the power supply unit can be electrically insulated from a power line. In this state, even though an overvoltage flows via the power line, the overvoltage cannot flow into the breaker, by means of which the circuits of the breaker cannot have any error operations or cannot be broken.

Moreover, the present invention may provide a current detection unit to detect in real time the current flowing via a power line, a display unit for display the detected current, the number of current leakage detections, the number of power failures, and the number of surge current entries, so a user can visually and easily check electrical states with eyes.

Furthermore, the present invention may provide a watchdog timer to monitor any error operations which might occur due to an instant surge current or power failure, and if a predetermined time passes, an interruption may be caused to occur, thus initializing a controller, whereupon a breaker can be automatically driven, which consequently makes it possible to stably supply electric power to any load.

### BRIEF DESCRIPTION OF DRAWINGS

FIG. 1 is a view illustrating a configuration of a digital current leakage breaker according to the present invention.

FIG. 2 is a view illustrating a configuration of a power supply unit which belongs to a digital current leakage breaker according to the present invention.

FIG. 3 is a view illustrating a configuration of a converter which belongs to a digital current leakage breaker according to the present invention.

FIGS. 4 to 8 are graphs for describing the operations of a converter in FIG. 3.

FIG. 9 is a view illustrating a configuration of a current detection unit which belongs to a digital current leakage breaker according to the present invention.

FIGS. 10 and 11 are graphs for describing the operations of a current detection unit in FIG. 9.

FIG. 12 is a view illustrating a configuration of a surge detector which belongs to a digital current leakage breaker according to the present invention.

FIGS. 13 to 15 are views illustrating the configurations of a conventional current leakage breaker.

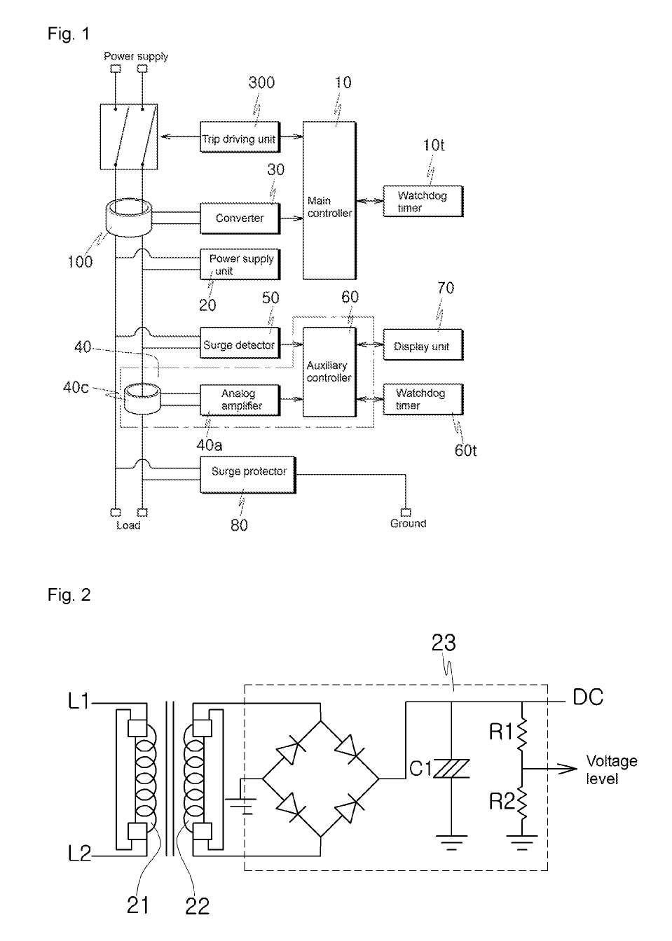

[Legend of reference numbers]

| | |
|---|---|
| 10: Main controller | 10t, 60t: Watchdog timer |

20: Power supply unit

| | | |
|---|---|---|
| 21: Primary winding | 22: Secondary winding | 23: DC power unit |

30: Converter

| | |
|---|---|
| 31: First channel 31a: First amplifier | 31c: First comparator |

| | | | |
|---|---|---|---|
| 32: Second channel | 32a: Second amplifier | 32c: | Second |

comparator
40: Current detection unit

| | |
|---|---|
| 40a: Amplification unit | 40c: Current transformer |

50: Surge detector

| | |
|---|---|
| 50a: Arrester | 50p: Photodiode |

| | | |
|---|---|---|
| 60: Auxiliary controller | 70: Display unit | 80: Surge protector |

### BEST MODES FOR CARRYING OUT THE INVENTION

The present invention will be described in detail with reference to the accompanying drawings. The accompanying drawings are provided for illustrative purposes to easily describe the contents and scope of the technical concepts of the present invention, not intended to limit or change the technical scope of the present invention. Moreover, it is obvious that various modifications and changes are available to a person having ordinary skill in the art within a scope of the technical concepts of the present invention based on the aforementioned examples.

In the present invention, since the power supply unit employed to supply electric power to the breaker is electrically insulated, whereby any damage to the breaker due to the entry of an overvoltage into the breaker can be prevented, and the number of current leakages, the number of power failures, and the number of surge current entries can be recorded and confirmed, and the currently used voltage can be monitored in real time.

In terms of the basic configuration of the digital current leakage breaker according to the present invention, the digital current leakage breaker may include, like a typical current leakage breaker, but is not limited to, a zero-phase current transformer (ZCT) 100 which is able to detect any leakage current from a power line, a main controller 10 which is able to control the driving of a trip driving unit based on a leakage current detected by the zero-phase current transformer 100, and a trip driving unit 300 which is configured to block the switch of the power line when any current leakage is detected. As illustrated in FIG. 2, the power supply unit 20 employed to supply electric power to such devices may be formed of a primary winding 21 connected to the side of electric power, and a secondary winding 22 wherein induced current flows based on any change to the magnetic field at the primary winding.

In the power supply unit 20, since the portions between the primary winding 21 and the secondary winding 22 are electrically insulated, a high voltage cannot enter the current leakage breaker even though the high voltage due to noises or current leakages flow via the power line.

The secondary winding 23 of the power supply unit 20 is equipped with a DC power unit 23 to supply a DC power to the breaker. The main controller 10 is formed of a small computer called a microprocessor. Since this microprocessor is driven by a DC power, the electric power supplied via the power supply unit 20 should be converted into a DC. For this reason, the DC power unit 23 is provided so as to convert an AC into a DC.

The DC power unit 23 may be configured using any of the AC/DC converters, but as illustrated in FIG. 2, it may be formed of a bridge diode, resistors (R1 and R2) and a condenser C1.

In the present invention, an output voltage can be detected by installing two resistors (R1 and R2). If a voltage over a reference voltage is detected, the supplied power can be blocked. More specifically, a voltage level between two resistors (R1 and R2) can be detected. Since a voltage between the resistor (R2) and the ground can be detected, it is possible to determine if the output from the DC power unit is over a set voltage level. If the voltage detected between the resistor (R2) and the ground is over a reference voltage previously set by the main controller 10, the electric power is blocked, thus preventing the circuits of the current leakage breaker from being damaged or having error operations due to the overvoltage.

The digital current leakage breaker according to the present invention is equipped with the main controller 10 formed of a microprocessor. Since the output signal detected by the zero-phase current transformer 100 should be converted into a designed kind of signal by the main controller, a converter 30 may be further provided between the zero-phase current transformer and the main controller 10.

The converter 30 is equipped with two channels 31 and 32 to convert all the analog signals detected by the zero-phase current transformer. As illustrated in FIG. 4, since the output waveform of the zero-phase current transformer 100 is a sine wave shape, it needs to convert the signal into a digital signal. Moreover, since a current generated by a weak current due to a current difference between two power lines is outputted, an output signal is very weak. For this reason, the output signal should be amplified.

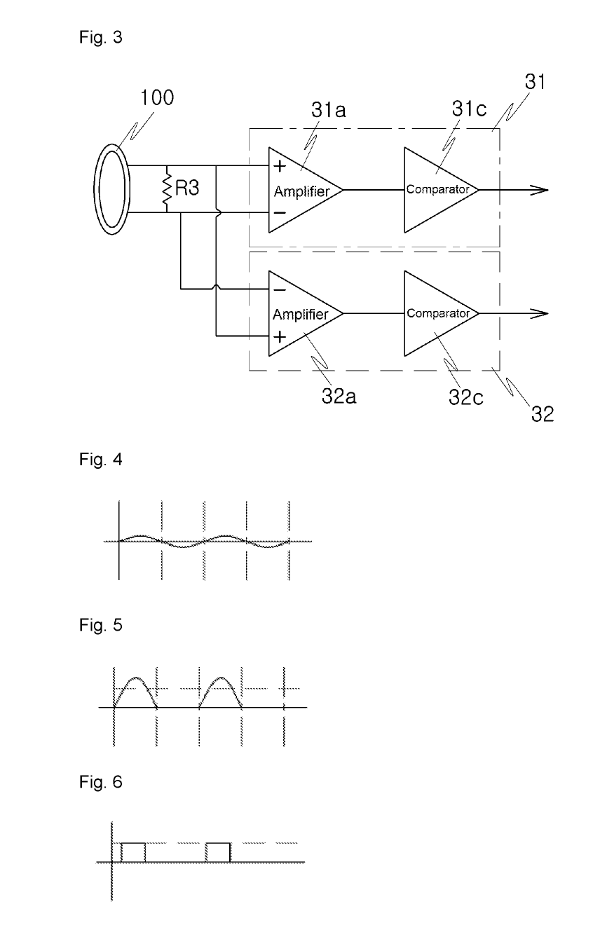

As illustrated in FIG. 3, for this operation, the converter 30 is equipped with an amplifier and a comparator. There are provided two channels 31 and 32 to amplify and convert the whole waveforms of the output signals from the zero-phase current transformer.

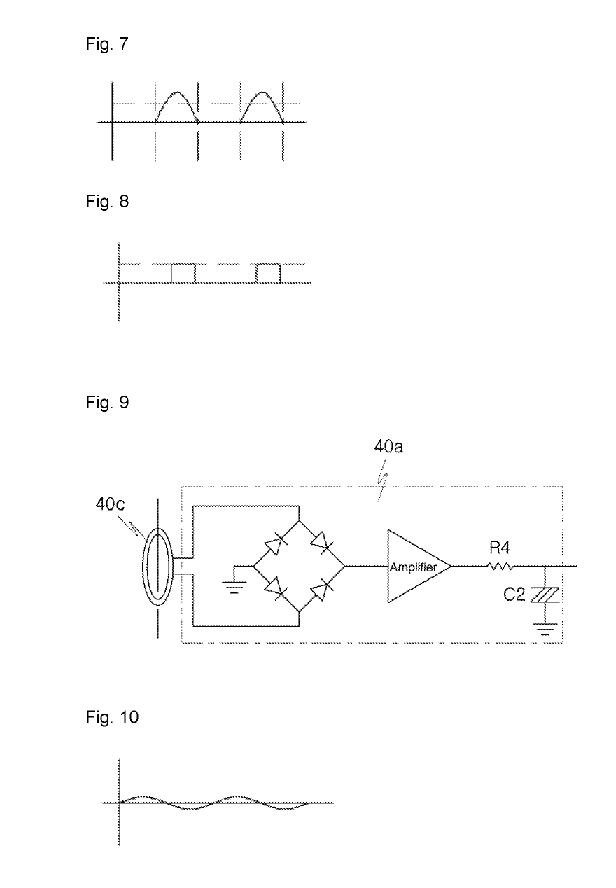

As illustrated in FIGS. 5 and 6, the first channel 31 is able to amplify and convert the portion (+) of the waveform, and as illustrated in FIGS. 7 and 8, the second channel 32 is able to amplify and convert the portion (−) of the waveform.

More specifically, the first channel 31 may be formed of a first amplifier 31a which is able to amplify the signal into a signal in FIG. 5 by amplifying only the signal of the portion (+) among the signals in FIG. 4, and the first comparator 31c which is able to compare the amplified signal in FIG. 5 by the first amplifier 31a to a reference value and output as a pulse value in FIG. 6.

The second channel 32 is configured in the same way as the first channel. The second channel 32 may be formed of a second amplifier 32a which is able to amplify only the value (−) among the output signals by connecting the pole of the amplifier reversely as compared to the first channel, and a second comparator 32c which is able to compare the amplified signal to a reference value and output as a pulse value. More specifically, the signal amplified and transformed by the second channel 32 may become a signal of the portion (−) in FIG. 7.

In the present invention, the pulse width of the signal which has amplified and transformed the whole portions of the output signal from the zero-phase current transformer 100 is detected, and if the pulsed width is over a previously set pulse width, it is determined that a current leakage has occurred, thus operating the breaker. In case of the conventional current leakage breaker, the current leakage state was determined using only the half-wave among the output signals of the zero-phase current transformer. In this case, the range to determine the current leakage is limited to only a part of the output signal, so even an instant noise was determined as a current leakage, thus blocking the electric power. For this reason, the electric power supplied to the load device was unintentionally blocked. In the present invention, an output signal propagation of the zero-phase current transformer is used as a reference for detecting a current leakage. In this way, the range for a current leakage blocking can be increased, by which it is possible to prevent a problem that an instant overcurrent is recognized as a current leakage.

The current leakage breaker may have an instant power failure due to a simple and instant noise or a predetermined external situation. If this instant power failure prolongs long, the load may have a lot of influences. For this, in the present invention, a watchdog timer 10t is further provided at the main controller 10, by which it is possible to automatically reset the main controller after a predetermined time has passed, thus supplying electric power.

It is preferred that the digital current leakage breaker according to the present invention is configured to break current leakage and detect noises, for example, a surge current, etc.

For this, there is further provided a surge detector 50 which is able to detect a surge current.

As illustrated in FIG. 12, the surge detector 50 may be formed of an arrester 50a which is installed at a power line and is able to generate light when a voltage higher than a predetermine voltage level is inputted, and a photodiode 50p which is able to receive light which is emitted from the arrester. More specifically, if an abnormal voltage flows at the power line, the arrester 50a will emit light, and the photodiode 50p receives the light, and electrons and positive electric charge holes generate, so current can flow via the photodiode. The auxiliary controller 60 will detect if an abnormal voltage flows via the power line by detecting the aforementioned current.

Moreover, the digital current leakage breaker according to the present invention may include a current detection unit 40 which is able to detect in real time the current flowing via the power line, and a display unit 70 which is able to display the current which has been detected in real time.

As illustrated in FIG. 9, the current detection unit 40 may include a current transformer 40c employed to detect current which flows via the power line, and an amplification unit 40a employed to amplify and rectify the current detected by the current transformer.

The current transformer 40c is a means to detect the current at any of two power lines and may be formed of any of typical current transformers. There is provided an amplification unit 40a which may operates as a means to amplify and convert the current detected by the current transformer 40c and supply to an auxiliary controller 60.

The amplification unit 40a may be formed of a bridge diode which is able to rectify the current detected by the current transformer, an amplifier, and a smoothing circuit. As illustrated in FIG. 9, the amplification circuit may be formed of a resistor (R4), and a condenser (C2).

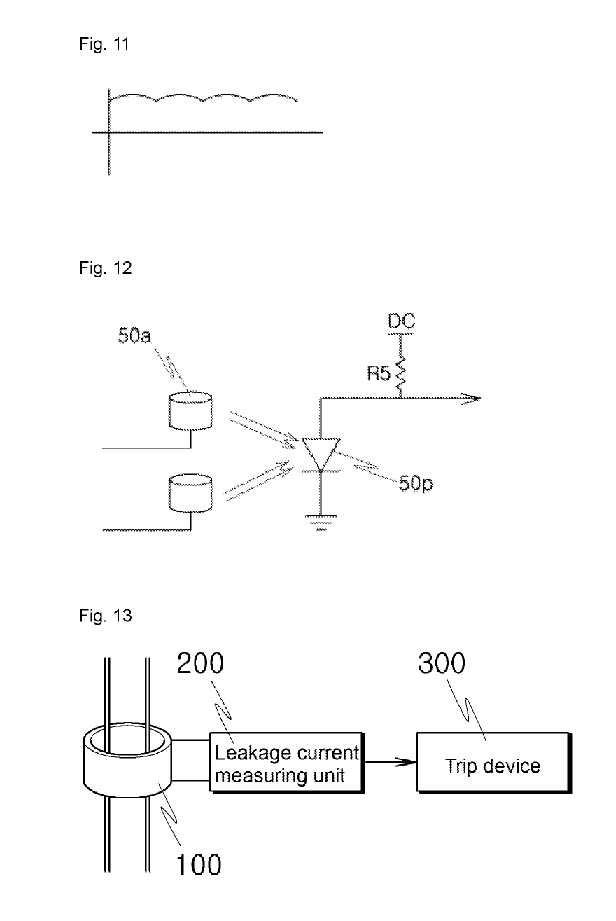

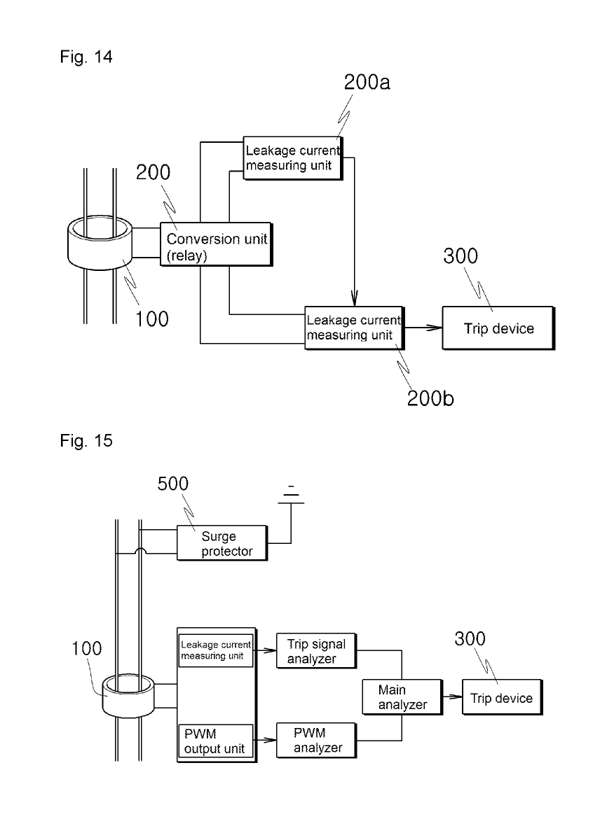

As illustrated in FIG. 10, the current detected by the current transformer 40c is a sine wave. The bridge diode rectifies the current and converts it into a DC, and the amplifier amplifies the DC, and the smoothing circuit smoothes the amplified signal into the form in FIG. 11.

The current of the power line which has been detected in real time, is transferred to the auxiliary controller 60 and is stored. The auxiliary controller 60 allows to display it on the display unit 70. The display unit 70 may be formed of a small size monitor, a digital display unit, etc.

The display unit 70 is able to display the real time current detected by the current detection unit 40 as well as the number of current leakage detections, the number of power failures, and the number of surge current entries, by which the user can recognize in real time the electric states at a time.

The auxiliary controller 60 may be formed of a microprocessor employed as a means to control the current detection unit 40, the surge detector 50, and the display unit 70. It is preferred that there is provided a watchdog timer 60t in the same way as in the main controller 10.

The digital current leakage breaker according to the present invention is equipped with the surge detector 50 to detect any surge current. It is preferred that a predetermined means to discharge a surge current when it is inputted, is further provided.

For this, there is further provided a surge protector 80 which may be installed at a front end or a rear end of the current leakage breaker connected to a main power line, thus discharging the surge current to the ground.

The surge protector 80 is employed to protect the load from an instant surge current. It may be installed at a front end or a rear end of the current leakage breaker. The surge protector may be disposed inside of the current leakage breaker, so only the installation of the current leakage breaker according to the present invention can concurrently implement a current leakage breaking function and a surface protection function. The aforementioned surge protector 80 is able to protect any load device from an electrical impact in such a way to discharge to the ground an instant abnormal current, for example, a noise, a surge, etc. occurring near the load device. It may be formed of any of currently available surge protectors which have been developed and are being currently used.

### INDUSTRIAL APPLICABILITY

The digital current leakage breaker according to the present invention is configured in such a way that the power supply unit is configured for an electric power to be supplied based on an induced current, so it can be electrically insulated from the power line. Even though an overcurrent flows via a power line, the overcurrent can be prevented from entering the breaker, whereby it is possible to prevent the circuits forming the breaker from having an error operation or being broken.

Moreover, the present invention has an industrial applicability since a watchdog timer is provided to monitor if the breaker has an error operation due to an instant surface or power failure, and if a predetermined time passes, it may cause an interruption, thus initializing the controller and subsequently allowing the breaker to automatically operate, by means of which electric power can be stably supplied to the loads.

1. A digital current leakage breaker wherein a main controller 10 operates a trip driving unit 300, thus blocking a main electric power, based on a leakage current which occurs at a power line and is detected using a zero-phase current transformer 100, comprising:
a power supply unit 20 which is employed to supply electric power to the current leakage breaker and includes a primary winding 21 connected to the power line, and a secondary winding 22 wherein an induced current generates based on any change to the magnetic field of the primary winding, by which an electrical insulation can be made between the primary winding and the secondary winding, wherein even though an unexpected high voltage flows via the power line, the high voltage does not inter the current leakage breaker.

2. The breaker of claim 1, wherein the secondary winding 22 of the power supply unit 20 includes a DC (Direct Current) power unit 23 to supply a DC power to the breaker, and two resistors (R1 and R2) are provided, which are able to block electric power if a voltage higher than a reference voltage is detected by detecting an output voltage, and a voltage between the resistor (R2) and the ground is detected, and if the detected voltage is higher than a set reference voltage, the voltage is blocked.

3. The breaker of either claim 1 or claim 2, wherein the zero-phase current transformer 100 comprises a converter 30 to convert the output signal of the zero-phase current transformer, and the converter 30 includes two channels 31 and 32, and the first channel 31 is formed of a first amplifier 31a to amplify only the value (+) among the output signals, and a first comparator 31c to compare the amplified signal to a reference value and outputs as a pulse value, and the second channel 32 is formed of a second amplifier 32a to amplify only the value (−) among the output signals, and a second comparator 32c to compare the amplified signal to a reference value and output as a pulse value.

4. The breaker of claim 1, wherein the main controller 10 comprises a watchdog timer 10t.

5. The breaker of claim 1, wherein the current leakage breaker comprises:
a current detection means 40 employed to detect in real time the current which flows via the power line;
a surge detector 50 which is able to detect a surge current;
an auxiliary controller 60 which is able to store and control the detected current; and
a display unit 70 which is configured to display the detected current, the number of current leakage detections, the number of power failures, and the number of surge current entries, wherein the current detection means 40 includes a current transformer 40c which is able to detect the current flowing via the power line, and an amplification unit 40a which is able to amplify and rectify the current detected by the current transformer.

6. The breaker of claim 5, wherein the surge detector 50 comprises an arrester 50a which is installed at the power line and generates light if a voltage higher than a predetermined voltage level is inputted, and a photodiode 50p which is configured to receive the light generated by the arrester, wherein a surge current is detected by detecting the voltages at both ends of the photodiode.

7. The breaker of claim 5, wherein the auxiliary controller 60 comprises a watchdog timer 60t.

8. The breaker of claim 1, further comprising a surge protector 80 which is installed at a front end or a rear end of the current leakage breaker connected to the main power line, thus discharging the surge current to the ground.
